(19) United States
(12) Patent Application Publication
(10) Pub. No.: US 2013/0281151 A1
(43) Pub. Date: Oct. 24, 2013

(54) ADDITIONAL FEATURE GROUP INDICATOR BIT HANDLING

(71) Applicants: NOKIA CORPORATION, Espoo (FI); NOKIA SIEMENS NETWORKS OY, Espoo (FI)

(72) Inventors: Jarkko Tuomo KOSKELA, Oulu (FI); Woonhee HWANG, Espoo (FI)

(21) Appl. No.: 13/838,797

(22) Filed: Mar. 15, 2013

Related U.S. Application Data
(60) Provisional application No. 61/611,767, filed on Mar. 16, 2012.

(51) Int. Cl. H04W 8/22

(52) U.S. Cl. CPC H04W 8/22
USPC 455/550.1

(57) ABSTRACT

The long term evolution (LTE) of the third generation partnership project (3GPP) and the evolved universal terrestrial radio network (EUTRAN) may benefit from user equipment (UE) capability handling. For example, UE capability handling can benefit from feature group indicator (FGI) handling. A method according to certain embodiments can include processing a received set of feature group indicators from a user equipment. The method can also include determining whether the user equipment supports extended feature group indicators based on whether the extended feature group indicator bits are present. The method can further include determining that the user equipment does not support extended feature group indicators when the extended feature group indicator bits are not present.

### CROSS REFERENCE TO RELATED APPLICATION

This application is related to and claims the priority of U.S. Provisional Patent Application Ser. No. 61/611,767, filed on Mar. 16, 2012, the contents of which are hereby incorporated by reference in their entirety.

### BACKGROUND

1. Field

The long term evolution (LTE) of the third generation partnership project (3GPP) and the evolved universal terrestrial radio network (EUTRAN) may benefit from user equipment (UE) capability handling. For example, UE capability handling can benefit from feature group indicator (FGI) handling.

2. Description of the Related Art

Conventionally, there is no provision for the kind of feature group indicator (FGI) handling described herein. The FGI concept as such is completely new in Release 8 (Rel-8) of LTE and having additional FGIs for frozen release is introducing new complexity for which there is no conventional simplification. For example, if the specification is frozen the existing parameter size cannot be changed unless extension mechanism had been already considered. The size of FGI parameter is fixed to 32 bits when it was defined in Rel-8 time frame.

### SUMMARY

According to a first embodiment, a method includes processing a received set of feature group indicators from a user equipment. The method also includes determining whether the user equipment supports extended feature group indicators based on at least one of a field group indicator that indicates that the user equipment supports extended feature group indicators or a user capability that indicates that the user equipment supports extended feature group indicators.

According to a second embodiment, an apparatus includes at least one processor and at least one memory including computer program code. The at least one memory and the computer program code are configured to, with the at least one processor, cause the apparatus at least to process a received set of feature group indicators from a user equipment. The at least one memory and the computer program code are also configured to, with the at least one processor, cause the apparatus at least to determine whether the user equipment supports extended feature group indicators based on at least one of a field group indicator that indicates that the user equipment supports extended feature group indicators or a user capability that indicates that the user equipment supports extended feature group indicators.

According to a third embodiment, an apparatus includes processing means for processing a received set of feature group indicators from a user equipment. The apparatus also includes determining means for determining whether the user equipment supports extended feature group indicators based on at least one of a field group indicator that indicates that the user equipment supports extended feature group indicators or a user capability that indicates that the user equipment supports extended feature group indicators.

According to a fourth embodiment, a non-transitory computer readable medium encoded with instructions that, when executed in hardware, perform a process. The process includes processing a received set of feature group indicators from a user equipment. The process also includes determining whether the user equipment supports extended feature group indicators based on at least one of a field group indicator that indicates that the user equipment supports extended feature group indicators or a user capability that indicates that the user equipment supports extended feature group indicators.

According to a fifth embodiment, an apparatus includes at least one processor and at least one memory including computer program code. The at least one memory and the computer program code are configured to, with the at least one processor, cause the apparatus at least to process a received set of feature group indicators from a user equipment. The at least one memory and the computer program code are also configured to, with the at least one processor, cause the apparatus at least to determine whether the user equipment supports extended feature group indicators based on whether the extended feature group indicators themselves are present. The at least one memory and the computer program code are further configured to, with the at least one processor, cause the apparatus at least to determine that the user equipment does not support extended feature group indicators when the extended feature group indicators are not present.

According to a sixth embodiment, an apparatus includes at least one processor and at least one memory including computer program code. The at least one memory and the computer program code are configured to, with the at least one processor, cause the apparatus at least to prepare a list of feature group indicators for transmission to a network. The at least one memory and the computer program code are also configured to, with the at least one processor, cause the apparatus at least to incorporate into the list a feature group indicator that indicates that extended field group indicators are supported.

### BRIEF DESCRIPTION OF THE DRAWINGS

For proper understanding of the invention, reference should be made to the accompanying drawings, wherein:

FIG. 1 illustrates a new feature group indicator (FGI) bit according to certain embodiments.

FIG. 2 illustrates a new user equipment (UE) capability according to certain embodiments.

FIG. 3 illustrates a method according to certain embodiments.

FIG. 4 illustrates another method according to certain embodiments.

FIG. 5 illustrates a further method according to certain embodiments.

FIG. 6 illustrates a system according to certain embodiments.

### DETAILED DESCRIPTION

Certain embodiments are related to long term evolution (LTE) and evolved universal terrestrial radio network (EUTRAN). Specifically, certain embodiments relate to handling of user equipment (UE) capabilities and feature group indicators (FGIs). New FGIs can be added into LTE, particular as the old FGIs run out if the specification is already frozen.

However, conventionally, a network (NW) may assume that a user equipment (UE) supports all the features indicated in the additional FGIs (featureGroupIndRel9Add) if the UE does not signal it. However, a UE that is simply unaware of these additional FGIs may be unable to include them. In this situation, conventionally the NW would assume that the UE supports all the features from new FGIs. Moreover, this approach may apply this same assumption for all legacy UEs, meaning UEs that are not aware of the use of featureGroupIndRel9Add, which was introduced in a change request in R-120355, which is incorporated herein in its entirety by reference.

For features that are linked to old FGI bits, it is possible that the old FGI bits may themselves answer whether the UE supports the features, such as those features in FGIs 33-36, which relate to the Inter-RAT ANR capabilities of the UE. (e.g. FGI 19) However, when new FGIs are introduced for features in the new FGI part which are not linked to features in the old FGI bits, then the network (NW) would conventionally assume that the UE supports the features defined in these new FGIs, if the UE omits the featureGroupIndRel9Add. As noted above, the legacy UE may not even be aware of featureGroupIndRel9Add, and consequently it may be impossible to include the new information element (IE). The missing information element leads to the network making a false or erroneous decision based on a conventional approach.

Certain embodiments provide ways of avoiding such a false or erroneous decision. According to certain embodiments, one bit (e.g. we call this bit as “FGI support bit” in this document.) can be used from the legacy FGIs. For example, original FGI, such as, FGI31 or FGI32, which were undefined, can be defined to have a new meaning.

For example, the FGI support bit can be defined to indicate whether the UE understands and is capable of processing the new FGIs (featureGroupIndRel9Add). Thus, if the UE sets this FGI support bit to true and omits the new FGIs, the network can determine that all the functionalities in the FGIs are supported by UE. Alternatively, if the UE sets this bit to false, which can be the default value, and omits the new FGIs, then the network can determine that the UE does not support any of the functionalities in the new FGI.

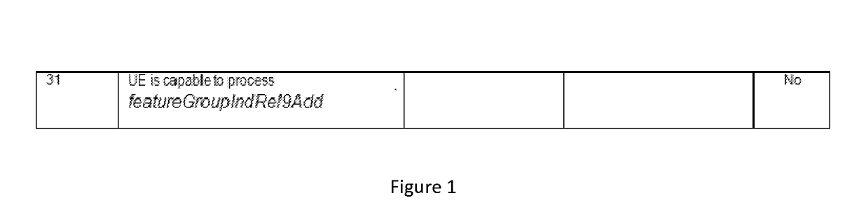

To implement such an embodiment, a bit can be used in the legacy FGI as the FGI support bit, for example, in 3GPP technical specification (TS) 36.331. FIG. 1 illustrates a FGI support bit according to certain embodiments. Then the UE and the network behavior can be defined.

The definition can indicate that if the optional field featureGroupIndRel9Add is not included by a UE of a future release and the UE has set a predetermined bit, FGI31 (e.g. FGI support bit) in FIG. 1, to 1, the network may, for example, assume that all features pertaining to the RATs supported by the UE, listed in Table B.1-1a and deployed in the network, have been implemented and tested by the UE. Table B.1-1a can be a list of new or extended FGIs, such as the Table B.1-1a in RP-120355. The definition can also indicate that if the optional field featureGroupIndRel9Add is not included by a UE of a future release and the UE has set the predetermined bit (e.g. FGI support bit), for example FGI31, to 0, the network can assume that all features pertaining to the RATs supported by the UE, listed in Table B.1-1a and deployed in the network, have not been implemented and tested by the UE.

Alternatively, the network can be configured to treat new FGIs in such a way that if the UE does not include new set of FGIs, then the UE does not support any of those. In other words, the assumption regarding the absence of the new FGIs can be the opposite of the conventional assumption.

To implement such an embodiment, the network can be configured such that it is clear that network will not assume that UE has been tested/implemented with respect to the new features if the UE does not include new FGIs. Of course, the features themselves do not need to be new, but the new features can simply be whatever features are described in the new FGIs and not already described in an existing FGI.

For example, the network can be configured such that if the optional field featureGroupIndRel9Add is not included by a UE of a future release, the network can assume that all features pertaining to the RATs supported by the UE, listed in Table B.1-1a and deployed in the network, have not been implemented and tested by the UE.

In another alternative, a new UE capability can be provided to indicate whether the UE supports featureGroupIndRel9Add or not. Thus, for example, if the UE includes this capability and sets “support” and omits the new FGIs, then the network can determine that all the functionalities in the FGI are supported by UE. On the other hand, if the UE does not include this capability (or include but set to “not support” depending on the signaling details), which may be the default, then the network may interpret the UE not including the capability as meaning that the UE does not support the functionality. Thus, when the UE omits the new FGIs, the network can consider that the UE does not support any of the functionalities in the new FGI.

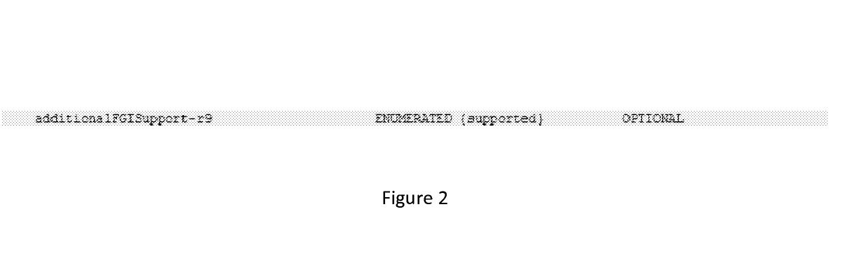

In order to implement this alternative, a UE capability can be added. FIG. 2 illustrates an added line to the UE capability according to certain embodiments. The UE and network behavior can be defined. For example, it can be defined that if the optional field featureGroupIndRel9Add, or another field that relates to extended FGIs, is not included by a UE of a future release and UE has set additionalFGISuport to “supported”, the network can assume that all features pertaining to the RATs supported by the UE, listed in Table B.1-1a and deployed in the network, have been implemented and tested by the UE.

Likewise, it can be defined that if the optional field featureGroupIndRel9Add is not included by a UE of a future release and the UE does not include additionalFGISupport (or included but set to “not supported” depending on the signaling details), the network can assume that all features pertaining to the RATs supported by the UE, listed in Table B.1-1a and deployed in the network, have not been implemented and tested by the UE.

Consequently, certain embodiments can, for example, permit a network to avoid making a false or erroneous decision regarding a legacy user equipment and its capabilities, particularly its support of features defined in new FGIs. Likewise, certain embodiments make it possible to utilize new FGIs. Furthermore, in certain embodiments, the network can clearly know whether the network can configure the feature listed in new FGIs or not.

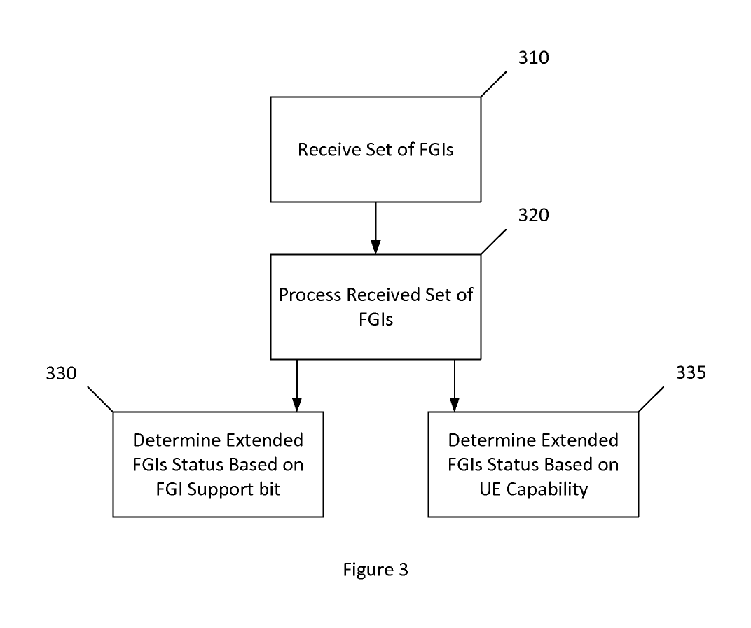

FIG. 3 illustrates a method according to certain embodiments. The method can be performed in a network element, such as an access point. As shown in FIG. 3, a method can include, at 310, receiving a set of FGIs. This set of FGIs can be received in response to a request for user equipment capabilities. The network element can then, at 320, process the received the set of FGIs. As a part of the processing, the network element can perform at least one of determining, at 330, extended FGIs status based on an FGI support bit, or, at 335, based on a UE capability.

The extended FGIs status can refer to whether or not the UE recognizes that the extended FGIs exist. The FGI support bit can refer to the bit that indicates such a status, as for example, FGI 31 in the example illustrated in FIG. 1. The FGI support bit can be a bit within the unextended range (for example, FGI 1-32).

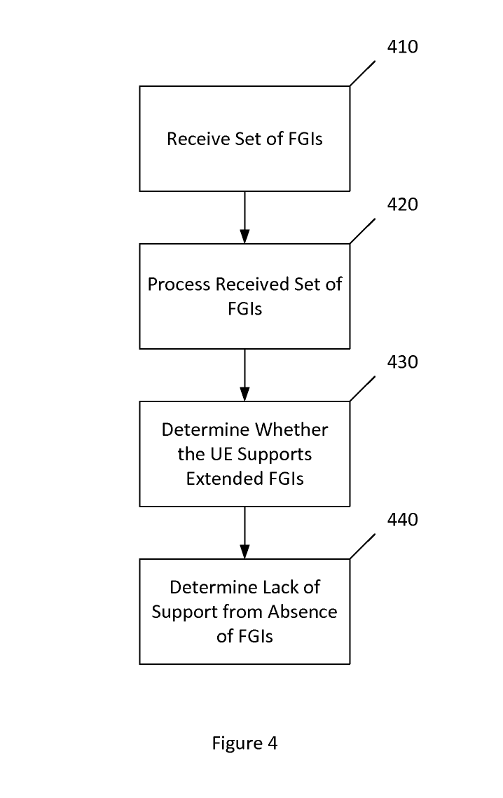

FIG. 4 illustrates another method according to certain embodiments. The method can be performed in a network element, such as an access point. As illustrated in FIG. 4, a method can include, at 410, receiving a set of feature group indicators. The set of feature group indicators may, for example, be responsive to a request regarding user equipment capabilities. The method can also include, at 420, processing the received set of feature group indicators from the user equipment. Moreover, the method can further include, at 430, determining whether the user equipment supports extended feature group indicators based on whether the extended feature group indicators themselves are present. The method can additionally include, at 440, determining that the user equipment does not support features in the extended feature group indicators when the extended feature group indicators are not present.

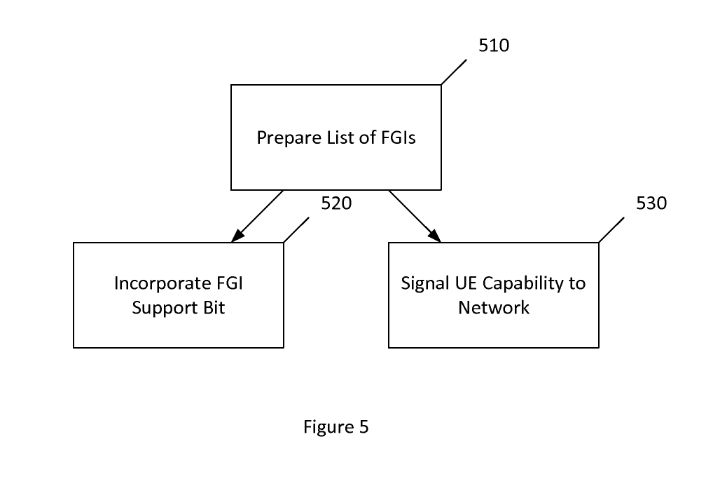

FIG. 5 illustrates a further method according to certain embodiments. The method may be performed by, for example, a user equipment. As shown in FIG. 5, the method can include preparing a list of FGIs. This list can be prepared in response to a previously received request. The list can be prepared for transmission to a network. The method can also include, at 520, incorporating into the FGI support bit that indicates that extended field group indicators are supported. Additionally or alternatively, the method can include, at 530, signaling a user equipment capability to the network.

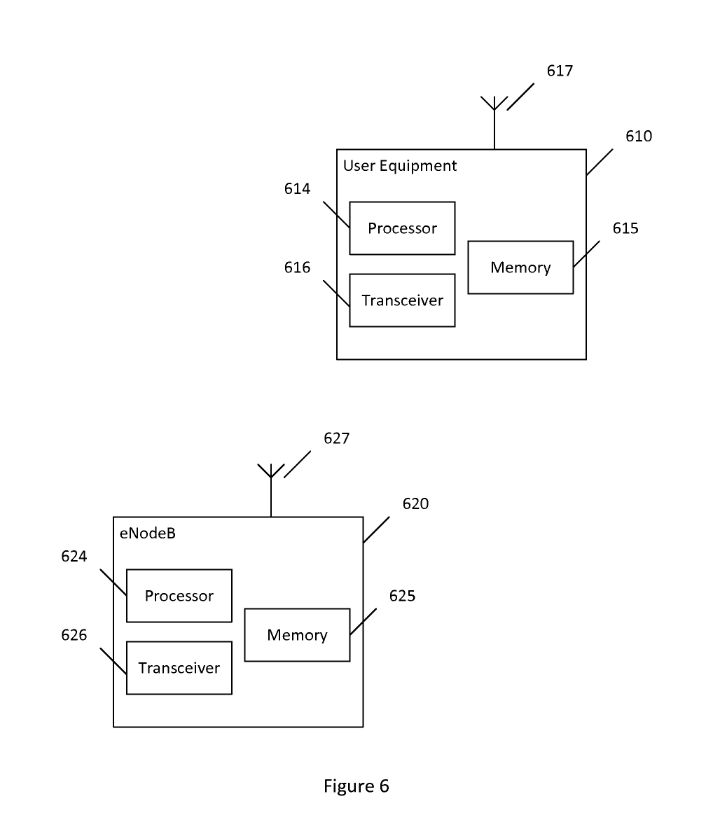

FIG. 6 illustrates a system according to certain embodiments. In an example embodiment, a system may include two devices, user equipment (UE) 610 and eNodeB 620. In this illustration, the eNodeB 620 is just one example of a network device. Each of the devices 610 and 620 may be equipped with at least one processor (respectively 614 and 624), at least one memory (respectively 615 and 625) (including computer program instructions or code), a transceiver (respectively 616 and 626), and an antenna (respectively 617 and 627). There is no requirement that each of these devices be so equipped. For example, the eNodeB 620 may be equipped for wired communication with a core network (not shown).

The transceiver (respectively 616 and 626) can be a transmitter, a receiver, both a transmitter and a receiver, or a unit that is configured both for transmission and reception. The transceiver (respectively 616 and 626) can be coupled to corresponding one or more antenna(s) (respectively 617 and 627), which may include a directional antenna.

The at least one processor (respectively 614 and 624) can be variously embodied by any computational or data processing device, such as a central processing unit (CPU) or application specific integrated circuit (ASIC). The at least one processor (respectively 614 and 624) can be implemented as one or a plurality of controllers.

The at least one memory (respectively 615 and 625) can be any suitable storage device, such as a non-transitory computer-readable medium. For example, a hard disk drive (HDD) or random access memory (RAM) can be used in the at least one memory (respectively 615 and 625). The at least one memory (respectively 615 and 625) can be on a same chip as the corresponding at least one processor (respectively 614 and 624), or may be separate from the corresponding at least one processor (respectively 614 and 624).

The computer program instructions may be any suitable form of computer program code. For example, the computer program instructions may be a compiled or interpreted computer program.

The at least one memory (respectively 615 and 625) and computer program instructions can be configured to, with the at least one processor (respectively 614 and 624), cause a hardware apparatus (for example, user equipment 610 or eNodeB 620) to perform a process, such as any of the processes described herein (see, for example, FIGS. 3-5).

Thus, in certain embodiments, a non-transitory computer-readable medium can be encoded with computer instructions that, when executed in hardware perform a process, such as one of the processes described herein. Alternatively, certain embodiments of the present invention may be performed entirely in hardware.

The devices of the system may also include additional components. For example, each of user equipment 610 and eNodeB 620 can include a user interface that is operable connected to the processor (respectively 614 and 624) and memory (respectively 615 and 625). That user interface can include a display, such as a liquid crystal display (LCD) or organic electroluminescent display (OELD), as well as speakers or audio outputs. Tactile outputs, such as a haptic feedback system, can also be included. The user interface may have a touch screen to receive user input. User input can also be provided by a keypad, keyboard, microphone, joystick, mouse, trackball, or other input device. Of course, there is no requirement that the devices include a user interface. For example, the eNodeB 620 may be embodied in part as a rack-mounted computer.

The devices of the system can also include peripheral devices that are connected wirelessly by, for example, a short-range wireless connection. Thus the devices of the system can be configured with more than one radio system, and can be configured for operation in more than one mode.

Various embodiments and modifications are permitted. For example, a method according to certain embodiments can include processing a received set of feature group indicators from a user equipment. The method can include determining whether the user equipment supports extended feature group indicators based on at least one of a field group indicator (e.g. FGI support bit) that indicates that the user equipment supports extended feature group indicators or a user capability that indicates that the user equipment supports extended feature group indicators.

An apparatus in certain embodiments can include at least one processor and at least one memory including computer program code. The at least one memory and the computer program code are configured to, with the at least one processor, cause the apparatus at least to process a received set of feature group indicators from a user equipment. The at least one memory and the computer program code are also configured to, with the at least one processor, cause the apparatus at least to determine whether the user equipment supports extended feature group indicators based on at least one of a field group indicator (e.g. FGI support bit) that indicates that the user equipment supports extended feature group indicators or a user capability that indicates that the user equipment supports extended feature group indicators.

In certain embodiments, an apparatus can include processing means for processing a received set of feature group indicators from a user equipment. The apparatus also can include determining means for determining whether the user equipment supports extended feature group indicators based on at least one of a field group indicator (e.g. FGI support bit) that indicates that the user equipment supports extended feature group indicators or a user capability that indicates that the user equipment supports extended feature group indicators.

According to certain embodiments, a non-transitory computer readable medium is encoded with instructions that, when executed in hardware, perform a process. The process can include processing a received set of feature group indicators from a user equipment. The process also can include determining whether the user equipment supports extended feature group indicators based on at least one of a field group indicator (e.g. FGI support bit) that indicates that the user equipment supports extended feature group indicators or a user capability that indicates that the user equipment supports extended feature group indicators.

A method according to certain embodiments can include processing a received set of feature group indicators from a user equipment. The method can include determining whether the user equipment supports extended feature group indicators based on whether the extended feature group indicators themselves are present. The method further can include determining that the user equipment does not support extended feature group indicators when the extended feature group indicators are not present.

An apparatus in certain embodiments can include at least one processor and at least one memory including computer program code. The at least one memory and the computer program code are configured to, with the at least one processor, cause the apparatus at least to process a received set of feature group indicators from a user equipment. The at least one memory and the computer program code are also configured to, with the at least one processor, cause the apparatus at least to determine whether the user equipment supports extended feature group indicators based on whether the extended feature group indicators themselves are present. The at least one memory and the computer program code are further configured to, with the at least one processor, cause the apparatus at least to determine that the user equipment does not support extended feature group indicators when the extended feature group indicators are not present.

In certain embodiments, an apparatus can include processing means for processing a received set of feature group indicators from a user equipment. The apparatus also can include determining means for determining whether the user equipment supports extended feature group indicators based on whether the extended feature group indicators themselves are present. The determining means are further for determining that the user equipment does not support extended feature group indicators when the extended feature group indicators are not present.

According to certain embodiments, a non-transitory computer readable medium is encoded with instructions that, when executed in hardware, perform a process. The process can include processing a received set of feature group indicators from a user equipment. The process also can include determining whether the user equipment supports extended feature group indicators based on whether the extended feature group indicators themselves are present. The process further can include determining that the user equipment does not support extended feature group indicators when the extended feature group indicators are not present.

A method according to certain embodiments can include preparing a list of feature group indicators for transmission to a network. The method also can include incorporating into the list a feature group indicator (e.g. FGI support bit) that indicates that extended field group indicators are supported.

An apparatus in certain embodiments can include at least one processor and at least one memory including computer program code. The at least one memory and the computer program code are configured to, with the at least one processor, cause the apparatus at least to prepare a list of feature group indicators for transmission to a network. The at least one memory and the computer program code are configured to, with the at least one processor, cause the apparatus at least to incorporate into the list a feature group indicator (e.g. FGI support bit) that indicates that extended field group indicators are supported.

In certain embodiments, an apparatus can include preparing means for preparing a list of feature group indicators for transmission to a network. The apparatus also can include incorporating means for incorporating into the list a feature group indicator (e.g. FGI support bit) that indicates that extended field group indicators are supported.

According to certain embodiments, a non-transitory computer readable medium is encoded with instructions that, when executed in hardware, perform a process. The process can include preparing a list of feature group indicators for transmission to a network. The process also can include incorporating into the list a feature group indicator (e.g. FGI support bit) that indicates that extended field group indicators are supported.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
processing a received set of feature group indicators from a user equipment, and
determining whether the user equipment supports extended feature group indicators based on at least one of a field group indicator that indicates that the user equipment supports extended feature group indicators or a user capability that indicates that the user equipment supports extended feature group indicators.

2. An apparatus, comprising at least one processor and at least one memory including computer program code, the at least one memory and the computer program code being configured to, with the at least one processor, cause the apparatus at least to:
process a received set of feature group indicators from a user equipment, and
determine whether the user equipment supports extended feature group indicators based on at least one of a field group indicator that indicates that the user equipment supports extended feature group indicators or a user capability that indicates that the user equipment supports extended feature group indicators.

3. An apparatus, comprising:
processing means for processing a received set of feature group indicators from a user equipment, and
determining means for determining whether the user equipment supports extended feature group indicators based on at least one of a field group indicator that indicates that the user equipment supports extended feature group indicators or a user capability that indicates that the user equipment supports extended feature group indicators.

4. A non-transitory computer readable medium encoded with instructions that, when executed in hardware, perform a process comprising:
processing a received set of feature group indicators from a user equipment, and
determining whether the user equipment supports extended feature group indicators based on at least one of a field group indicator that indicates that the user equipment supports extended feature group indicators or a user capability that indicates that the user equipment supports extended feature group indicators.

5. An apparatus comprising at least one processor and at least one memory including computer program code, the at least one memory and the computer program code being configured to, with the at least one processor, cause the apparatus at least to:
process a received set of feature group indicators from a user equipment;
determine whether the user equipment supports extended feature group indicators based on whether the extended feature group indicators themselves are present, and
determine that the user equipment does not support extended feature group indicators when the extended feature group indicators are not present.

6. An apparatus comprising at least one processor and at least one memory including computer program code, the at least one memory and the computer program code being configured to, with the at least one processor, cause the apparatus at least to:
prepare a list of feature group indicators for transmission to a network, and
incorporate into the list a feature group indicator that indicates that extended field group indicators are supported.
